(19) United States
(12) Patent Application Publication
(10) Pub. No.: US 2017/0291452 A1
(43) Pub. Date: Oct. 12, 2017

(54) Rigidity Reinforcement Ring and Tire Vulcanizing Method Using Same

(71) Applicant: The Yokohama Rubber Co., LTD., Minato-ku, Tokyo (JP)

(72) Inventors: Hajime Satoh, Hiratsuka-shi, Kanagawa (JP); Kenta Yamamura, Hiratsuka-shi, Kanagawa (JP)

(73) Assignee: The Yokohama Rubber Co., LTD., Minato-ku, Tokyo (JP)

(21) Appl. No.: 15/507,725

(22) PCT Filed: Aug. 20, 2015
(86) PCT No.: PCT/JP2015/073396

§ 371 Date: Feb. 28, 2017

(30) Foreign Application Priority Data
Aug. 28, 2014 (JP) 2014-173492
Aug. 29, 2014 (JP) 2014-175261
Oct. 27, 2014 (JP) 2014-218485

(51) Int. Cl. B60C 5/08; B60C 99/00

(52) U.S. Cl. CPC B60C 5/08; B60C 99/00

(57) ABSTRACT

Provided is a pneumatic tire vulcanizing method which includes the steps of setting a green tire in a mold, inserting a bladder inside the green tire, and expanding the bladder to press the bladder to an outer side in the tire radial direction and perform vulcanization molding. The bladder is expanded with a rigidity reinforcement ring interposed between an inner circumferential surface of a region of the green tire corresponding to a tread portion and an outer circumferential surface of a region of the bladder corresponding to the tread portion.

### TECHNICAL FIELD

The present technology relates to an annular member used in vulcanization molding of a pneumatic tire, and a tire vulcanizing method using the same.

### BACKGROUND ART

Often, as a method of vulcanization molding a pneumatic tire, a green tire is set in a mold, a vulcanization bladder is inserted in the green tire, and steam or the like is injected into the vulcanization bladder, filling and expanding the vulcanization bladder and causing the green tire to become pressurized and heated. However, in vulcanization molding that uses a vulcanization bladder, the constituent members of the pneumatic tire may move, causing the members to not be disposed as designed. In such a case, the pneumatic tire may not exhibit the expected tire performance. Further, in order to manufacture a pneumatic tire having high performance, a disposition accuracy of the tire components needs to be further increased.

To increase a dimensional precision of the pneumatic tire and thus increase tire performance, a vulcanizing method that uses a rigid inner ring as an inner mold has been proposed (refer to Japanese Unexamined Patent Application Publication No. 2007-69497A, for example). However, in the vulcanizing method that uses the rigid inner ring, difficulties arise in coping with thermal expansion of the tire during vulcanization, causing problems such as a limit to applicable tire shapes, difficulties in removing the vulcanized tire from the inner mold, which results in low productivity, and increased manufacturing costs. As a result, a vulcanizing method of a pneumatic tire which allows an increase in the dimensional precision of the pneumatic tire and, at the same time, prevents a decrease in productivity and a degree of freedom in designing has been in demand.

Further, as a method for vulcanization molding a pneumatic tire, there is known a vulcanization molding method, i.e., so-called bladder-less vulcanization, of setting a green tire in a mold and injecting a heating medium into the green tire (refer to Japanese Unexamined Patent Application Publication Nos. 2001-260135A and 2009-208394A, for example).

However, in bladder-less vulcanization, the heating medium may not be adequately pressed into the mold in regions where the green tire is thick, resulting in problems such as a limit to the applicable tire shapes, and inadequacies in an inner surface shape and the dimensional precision of the vulcanized tire. As a result, a vulcanizing method of vulcanizing a pneumatic tire without a bladder so as to ensure excellent bladder-less vulcanization productivity and, at the same time, prevent deterioration of the inner surface shape and the dimensional precision of the vulcanized tire has been in demand.

### SUMMARY

The present technology provides an annular member used in vulcanization molding which allows an increase in a dimensional precision of a pneumatic tire and, at the same time, prevents a decrease in productivity and a degree of freedom in designing, and a tire vulcanizing method using the annular member.

A rigidity reinforcement ring and a tire vulcanizing method using the rigidity reinforcement ring according to the present technology that achieve the above-described object are configured by (1) to (23) below.

(1) A rigidity reinforcement ring serving as a cylindrical ring that, when a green tire is set in a mold and a bladder is pressed from an inner side of the green tire to an outer side in a tire radial direction to perform vulcanization molding, is interposed between an inner circumferential surface of a region of the green tire corresponding to a tread portion and an outer circumferential surface of a region of the bladder corresponding to the tread portion. With such a ring, a stress required to cause a predetermined amount of tensile deformation in a circumferential direction of the ring is greater than a stress required to cause a predetermined amount of compressive deformation in the circumferential direction.

(2) The rigidity reinforcement ring described in (1), wherein an outer diameter of the ring is substantially equivalent to an inner diameter of a vulcanized tire, a width of the ring is substantially equivalent to a width of the tread portion of the vulcanized tire, and the vulcanized tire and the bladder are separatable.

(3) The rigidity reinforcement ring described in (1) or (2), wherein the ring is obtained by covering a reinforcing body with an unvulcanized rubber and vulcanizing the covered reinforcing body. The reinforcing body is obtained by winding a reinforcing wire having a twisted structure in at least a tire circumferential direction.

(4) The rigidity reinforcement ring described in any one of (1) to (3), wherein a tensile rigidity of the ring in the tire circumferential direction is greater than a tensile rigidity of the bladder in the tire circumferential direction.

(5) The rigidity reinforcement ring described in any one of (1) to (4), wherein the ring includes recesses and protrusions on an outer circumferential surface thereof.

(6) The rigidity reinforcement ring described in (5), wherein the recesses and protrusions of the ring continuously extend along the circumferential direction.

(7) The rigidity reinforcement ring described in any one of (1) to (6), wherein the ring is formed by a main portion having a thickness t and a tapered portion disposed on both sides of the main portion, and a thickness of the tapered portion gradually decreases from the thickness t toward an outer end portion in the width direction of the ring.

(8) The rigidity reinforcement ring described in (7), wherein a thickness of the outer end portion of the tapered portion is not greater than one-half of the thickness t.

(9) The rigidity reinforcement ring described in (7) or (8), wherein a distance L from the outer end portion to an inner end portion of the tapered portion has a relationship with the thickness t such that t≦L≦6t.

(10) The rigidity reinforcement ring described in any one of (7) to (9), wherein at least the tapered portion is fiber reinforced.

(11) The rigidity reinforcement ring described in (10), wherein the outer side and/or inner side in the radial direction of the tapered portion is fiber reinforced.

(12) The rigidity reinforcement ring described in any one of (1) to (11), wherein the ring includes a side ring on both sides in the width direction of the ring, and extends so that the side rings each come into contact with an entire inner side surface of a region corresponding to that from the tread portion to a bead portion of the green tire.

(13) The rigidity reinforcement ring described in claim (12), wherein a plurality of the reinforcing wires having the twisted structure and identical or differing reinforcing wires are disposed so as to extend in the tire radial direction and be spaced apart in the tire circumferential direction, in the bead portion of each of the side rings.

(14) A tire vulcanizing method including the steps of setting a green tire in a mold, inserting a bladder inside the green tire, expanding the bladder to press the bladder to an outer side in a tire radial direction, and performing vulcanization molding. The bladder is expanded with the rigidity reinforcement ring described in any one of (1) to (13) interposed between an inner circumferential surface of a region of the green tire corresponding to a tread portion and an outer circumferential surface of a region of the bladder corresponding to the tread portion.

(15) The tire vulcanizing method described in (14), further including the steps of manufacturing a green tire assembly obtained by integrally assembling constituent members of the green tire to an outer periphery of the rigidity reinforcement ring described in any one of (1) to (13), and setting the green tire assembly in the mold.

(16) The tire vulcanizing method described in (14), further including the steps of manufacturing a green tire assembly by inserting the rigidity reinforcement ring described in any one of (1) to (13) into a cavity of a green tire formed in advance, and inserting the bladder inside the green tire assembly.

(17) The tire vulcanizing method described in (15) or (16), further including the step of setting the green tire assembly in a mold divisible into a plurality of sections.

(18) A rigidity reinforcement ring serving as a ring that, when a green tire is set in a mold and a heating medium is injected inside the green tire and then pressed to an outer side in the tire radial direction to perform bladder-less vulcanization, is disposed so as to come into contact with an entire inner side surface of a region corresponding to that from a tread portion to a bead portion of the green tire. With such a ring, a stress required to cause a predetermined amount of tensile deformation in the tread portion and the bead portion of the ring is greater than a stress required to cause a predetermined amount of compressive deformation in the circumferential direction.

(19) The rigidity reinforcement ring described in (18), wherein the ring is obtained by covering a reinforcing body with an unvulcanized rubber and vulcanizing the covered reinforcing body. The reinforcing body is obtained by winding a reinforcing wire having a twisted structure in at least a tire circumferential direction, in the tread portion and the bead portion.

(20) The rigidity reinforcement ring described in claim (19), wherein a plurality of the reinforcing wires having the twisted structure and identical or differing reinforcing wires are disposed so as to extend in the tire radial direction and be spaced apart in the tire circumferential direction, in the bead portion of the ring.

(21) A tire vulcanizing method serving as a bladder-less vulcanizing method comprising the steps of setting a green tire in a mold, injecting a heating medium inside the green tire, and pressing the heating medium to an outer side in a tire radial direction. The heating medium is injected in a state with the rigidity reinforcement ring described in any one of (18) to (20) disposed across an entire inner side surface of a region corresponding to that from a tread portion to a bead portion of the green tire.

(22) The tire vulcanizing method described in (21), further including the steps of manufacturing a green tire assembly obtained by integrally assembling constituent members of the green tire to an outer periphery of the rigidity reinforcement ring described in any one of (18) to (20), and setting the green tire assembly in the mold.

(23) The tire vulcanizing method described in (22), further including the step of setting the green tire assembly in a mold divisible into a plurality of sections.

According to the rigidity reinforcement ring and the tire vulcanizing method that uses the rigidity reinforcement ring of the present technology, vulcanization molding is performed with the rigidity reinforcement ring disposed between the inner circumferential surface of the green tire corresponding to the tread portion and the outer peripheral surface of the bladder corresponding to the tread portion, the rigidity reinforcement ring having a tensile stress greater than a compressive stress in the circumferential direction. As a result, an outer diameter of the bladder is kept from ballooning, thereby making it possible to limit a shape of the inner circumferential surface of the tire and regulate a thickness of the tire in the tire radial direction. Further, the bladder is kept from expanding in the tire radial direction and expansion in the tire width direction is increased, making it possible to decrease a thickness in a shoulder portion of the tire. This makes it possible to increase the dimensional precision of the pneumatic tire. Furthermore, the outer diameter and width of the rigidity reinforcement ring can be adjusted as appropriate, making it possible to further increase the degree of freedom in tire designing. Moreover, the rigidity reinforcement ring may be simply used with an existing bladder, thereby maintaining productivity and not causing an increase in manufacturing costs. Further, in this tire vulcanizing method, the green tire is vulcanized using a rigidity reinforcement ring of (1) to (13) described above, thereby increasing dimensional precision and making it possible to manufacture a high quality pneumatic tire in a stable manner at low cost.

According to the rigidity reinforcement ring and the tire vulcanizing method using the rigidity reinforcement ring of the second aspect of the present technology, bladder-less vulcanization is performed with the rigidity reinforcement ring disposed so as to come into contact with the entire inner side surface of the region corresponding to that from the tread portion to the bead portion of the green tire, the rigidity reinforcement ring having a tensile stress greater than a compressive stress in the circumferential direction. As a result, this rigidity reinforcement ring makes an inner surface shape of the tire excellent and increases dimensional precision. Further, the rigidity reinforcement ring may be simply disposed on the inner circumferential surface of the green tire, making it possible to maintain favorable bladder-less vulcanization productivity. Further, in this tire vulcanizing method, the green tire is vulcanized without a bladder using a rigidity reinforcement ring of (18) to (20) described above, thereby increasing dimensional precision and making it possible to manufacture a high quality pneumatic tire in a stable manner at low cost.

### BRIEF DESCRIPTION OF DRAWINGS

FIG. 1 is an explanatory view schematically illustrating, in a cross section in a meridian direction, an example of an embodiment of a tire vulcanizing method that uses a rigidity reinforcement ring according to the present technology.

FIGS. 2A and 2B are explanatory views schematically illustrating an example of an embodiment of the rigidity reinforcement ring according to the present technology. FIG. 2A is a perspective view of the rigidity reinforcement ring, and FIG. 2B is a perspective view illustrating the rigidity reinforcement ring in FIG. 2A with a portion of a surface removed.

FIG. 3 is a perspective view illustrating another example of an embodiment of the rigidity reinforcement ring according to the present technology.

FIG. 4 is a cross-sectional view schematically illustrating another example of the embodiment in FIG. 3, with an outer circumferential surface having a different shape.

FIG. 5 is a cross-sectional view schematically illustrating yet another example of the embodiment in FIG. 3, with the outer circumferential surface having a different shape.

FIG. 6 is a cross-sectional view schematically illustrating yet another example of the embodiment of FIG. 3, with the outer circumferential surface having a different shape.

FIGS. 7A to 7C are cross-sectional views schematically illustrating examples of an auxiliary ring fitted together with the outer circumferential surface of the embodiment in FIG. 3. FIGS. 7A to 7C are cross-sectional views schematically illustrating the examples, each with the outer circumferential surface of the auxiliary ring having a different shape.

FIG. 8 is a perspective view illustrating yet another example of an embodiment of the rigidity reinforcement ring according to the present technology.

FIG. 9 is a partially enlarged cross-sectional view of a tapered portion of the rigidity reinforcement ring illustrated in FIG. 8.

FIGS. 10A to 10C are partial cross-sectional views corresponding to FIG. 9. FIG. 10A is a cross-sectional view of an embodiment of the rigidity reinforcement ring with the tapered portion fiber reinforced on an outer side in the radial direction, FIG. 10B is a cross-sectional view of an embodiment of the rigidity reinforcement ring with a main portion and the tapered portion fiber reinforced on the outer side in the radial direction, and FIG. 10C is a cross-sectional view of the rigidity reinforcement ring with the main portion and the tapered portion fiber reinforced on the outer side in the radial direction and the tapered portion fiber reinforced on an inner side.

FIGS. 11A and 11B are perspective views illustrating embodiments of the rigidity reinforcement ring with a portion of the surface removed. FIG. 11A is a perspective view of the rigidity reinforcement ring with the main portion and the tapered portion fiber reinforced on the outer side in the radial direction, and FIG. 11B is a perspective view of the rigidity reinforcement ring with the main portion and the tapered portion fiber reinforced on the outer side in the radial direction and the tapered portion fiber reinforced on the inner side in the radial direction.

FIGS. 12A to 12C are explanatory views schematically illustrating yet other examples of embodiments of the rigidity reinforcement ring according to the present technology. FIG. 12A is a perspective view with a reinforcing body internally wound in a tire circumferential direction, and a portion of the surface of the rigidity reinforcement ring removed. FIG. 12B is a perspective view with a reinforcing wire on an outer side in the radial direction of the reinforcing body wound in the circumferential direction of the rigidity reinforcement ring in FIG. 12A, and a portion of the surface removed in a two-choice system. FIG. 12C is a perspective view with the reinforcing wire on the tapered portions on the outer sides in the radial direction of the reinforcing body wound in the circumferential direction of the rigidity reinforcement ring in FIG. 12A, and a portion of the surface removed in a two-choice system.

FIGS. 13A and 13B are explanatory views schematically illustrating yet other examples of an embodiment of the rigidity reinforcement ring according to the present technology. FIG. 13A is a perspective view of the rigidity reinforcement ring that includes side rings, and FIG. 13B is a perspective view illustrating the rigidity reinforcement ring in FIG. 13A with a portion of the surface removed.

FIG. 14 is a perspective view corresponding to FIG. 13B, illustrating yet another example of an embodiment of the rigidity reinforcement ring according to the present technology.

FIGS. 15A to 15C are explanatory views schematically illustrating the opening and closing of a mold during vulcanization. FIG. 15A is a cross-sectional view when a green tire is set in the mold, FIG. 15B is a cross-sectional view during vulcanization, and FIG. 15C is a cross-sectional view in a tire equator direction when a vulcanized tire is removed.

FIG. 16 is an explanatory view schematically illustrating, in a cross section in a meridian direction, another example of an embodiment of a tire vulcanizing method that uses the rigidity reinforcement ring according to the present technology.

FIG. 17 is a cross-sectional view of a bladder expanded during vulcanization in a working example that uses the rigidity reinforcement ring according to the present technology.

FIG. 18 is a cross-sectional view of the bladder expanded during vulcanization in a comparative example illustrating prior art.

### DETAILED DESCRIPTION

A rigidity reinforcement ring according to the present technology will now be described on the basis of the embodiments illustrated in the drawings.

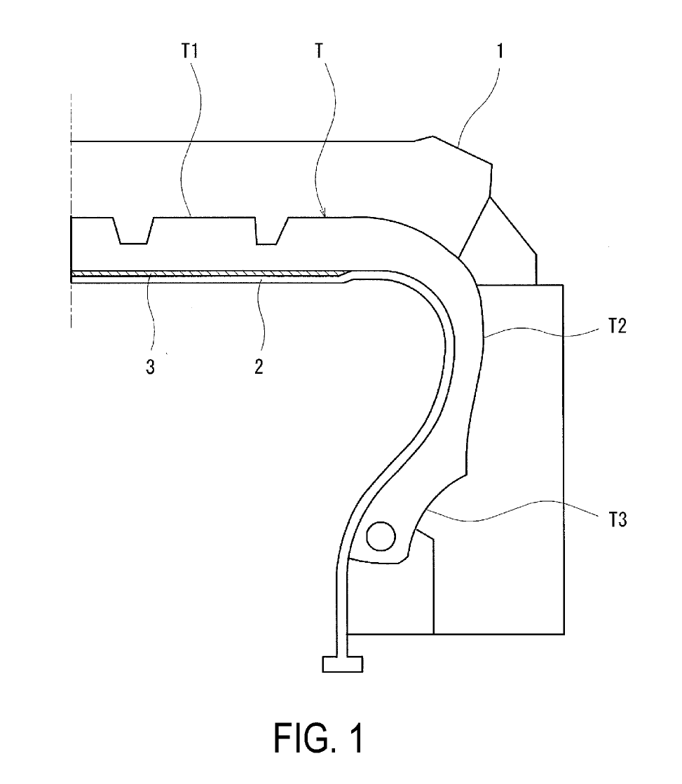

FIG. 1 is an explanatory view schematically illustrating a mold 1 during vulcanization molding, a vulcanization bladder 2 (hereinafter referred to as “bladder 2”), and a green tire T. FIG. 1 illustrates a state in which the green tire T is pressed against an inner surface of the mold 1 by the expansion of the bladder 2. Further, the green tire T is formed by a tread portion T1, a side portion T2, and a bead portion T3.

According to the present technology, a rigidity reinforcement ring 3 is disposed between an inner circumferential surface of a region of the green tire T corresponding to the tread portion T1, and an outer circumferential surface of a region of the bladder 2 corresponding to the tread portion T1. The rigidity reinforcement ring 3 is a cylindrical-shaped ring, and requires that a stress required to cause a predetermined amount of tensile deformation in a circumferential direction of the ring is greater than a stress required to cause a predetermined amount of compressive deformation in the circumferential direction. That is, the rigidity reinforcement ring 3 is susceptible to contracting and not susceptible to elongation in the tire circumferential direction.

The rigidity reinforcement ring 3 is externally fitted to an outer periphery of the bladder 2, making the rigidity reinforcement ring 3 less susceptible to elongation in the circumferential direction and changes in diameter when the bladder 2 expands during vulcanization molding. This keeps an outer diameter of the bladder, especially a center in a crown portion (tread portion), from ballooning against an intention of a tire designer, and restricts a peripheral shape of the bladder 2. That is, use of the rigidity reinforcement ring 3 makes it possible to limit a shape of an inner circumferential surface of the tire when the bladder 2 expands during vulcanization molding, regulate a thickness in a tire radial direction of the region corresponding to the tread portion, and increase dimensional precision. Thus, the rigidity reinforcement ring 3 preferably has a tensile rigidity in the tire circumferential direction that is greater than a tensile rigidity in the tire circumferential direction of the bladder 2.

Further, the bladder 2 externally fitted to the rigidity reinforcement ring 3 is restricted in terms of expansion in the tire radial direction, and thus readily expands toward the opening of the rigidity reinforcement ring 3, that is, in a tire width direction. This makes it possible to perform adequate heating and pressurization treatment on a shoulder region of the green tire, which has been one cause of increased vulcanization time due to difficulties in applying an adequate pressing force as a result of relatively late contact with the inner surface of the mold. That is, use of the rigidity reinforcement ring 3 makes it possible to decrease a thickness of a shoulder portion of the tire, increase dimensional precision, and shorten the vulcanization time.

In addition to a large tensile stress in the circumferential direction, the rigidity reinforcement ring 3 has a small compressive stress in the circumferential direction. During an initial stage of vulcanization molding of a tire, vulcanization of rubbers, such as a belt layer and a carcass near the tire inner surface, progresses. During the intermediate and subsequent stages, vulcanization of the entire tire cross section, including the tire interior, progresses. With the progression of vulcanization of unvulcanized rubber, the rubber increases in volume by thermal expansion. As a result, when vulcanization of the entire tire cross section progresses in the intermediate and subsequent stages, the vulcanized rubber near the tire inner surface, having started vulcanization in the initial stage by thermal expansion, deforms on the inner side in the radial direction in such a way that a circumferential length of a tire cavity contracts. Thus, the rigidity reinforcement ring 3 having a circumferential length that expanded by thermal expansion of the bladder 2 during the initial stage of vulcanization molding needs to be reduced in circumferential length in the intermediate and subsequent stages. The rigidity reinforcement ring 3 according to the present technology has a small compressive stress in the circumferential direction, allowing the rigidity reinforcement ring 3 to follow a behavior of the vulcanized rubber in the intermediate and subsequent stages and prevent the occurrence of failures such as buckling.

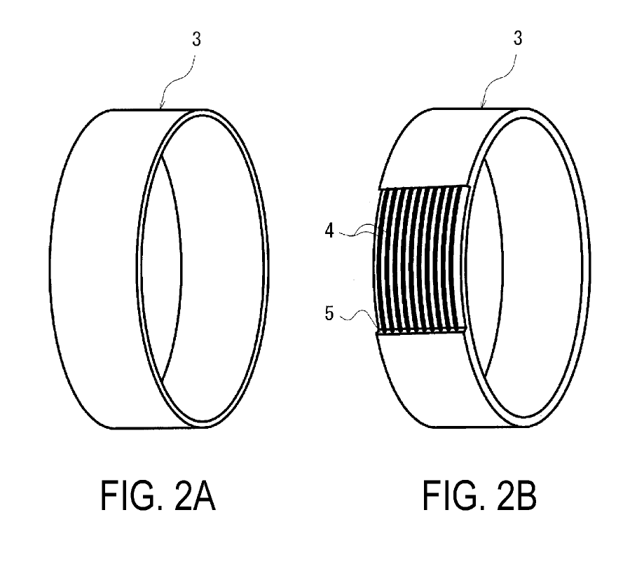

FIGS. 2A and 2B are explanatory views schematically illustrating an example of an embodiment of the rigidity reinforcement ring 3 according the present technology. As illustrated in FIGS. 2A and 2B, the rigidity reinforcement ring 3 is a cylindrical ring. While the dimensions are not particularly limited, preferably an outer diameter of the ring is substantially the same as an inner diameter of a vulcanized tire, and a width of the ring is substantially the same as a width of a tread portion of the vulcanized tire. This makes it possible to adjust a shape of the region corresponding to the tread portion of the tire, on the inner side in the radial direction.

Note that, while FIG. 2A illustrates the rigidity reinforcement ring 3 having a cylindrical shape with the outer diameter uniform in the tire width direction, the outer diameter of the rigidity reinforcement ring 3 is not limited to that in the illustrated example. For example, when a pneumatic tire designed with a tire cross section having a linear inner circumferential edge is manufactured, the rigidity reinforcement ring 3 illustrated in FIG. 2A may be used as is. On the other hand, when a pneumatic tire designed with a tire cross section having an arc-shaped inner circumferential edge is manufactured, the outer diameter of the rigidity reinforcement ring 3 may be changed in the tire width direction so as to follow the designed arc. That is, the shape of the rigidity reinforcement ring 3 may be determined in accordance with the cross-sectional shape of the designed tire. This makes it possible to further increase the degree of freedom in tire designing.

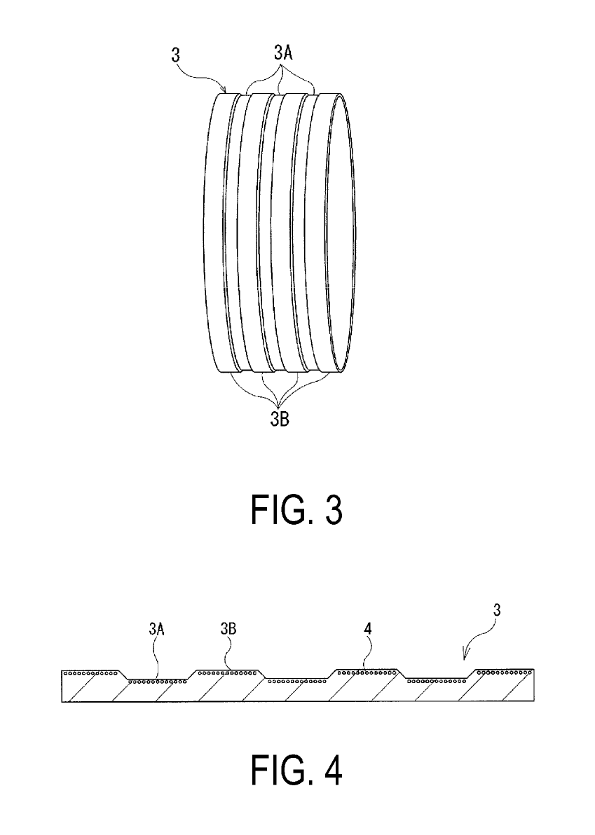

The configuration of the rigidity reinforcement ring 3 is not particularly limited as long as the tensile stress in the circumferential direction is greater than the compressive stress. The rigidity reinforcement ring 3, for example, is preferably a ring obtained by covering a reinforcing body with an unvulcanized rubber 5, and then vulcanizing the covered reinforcing body, as illustrated in FIG. 3. In such a configuration, the reinforcing body is obtained by winding a reinforcing wire 4 having a twisted structure in at least the tire circumferential direction. With the rigidity reinforcement ring 3 configured using a vulcanized rubber made from the reinforcing wire having a twisted structure, the tensile stress in the circumferential direction is increased and the compressive stress in the circumferential direction is decreased. Further, the rigidity reinforcement ring 3 is preferably configured so as to not adhere with the unvulcanized rubber or the bladder. This makes it possible to achieve excellent releaseability of the vulcanized tire. Further, the rigidity reinforcement ring 3 can be easily separated and removed from the inner side of the vulcanized tire removed from the mold 1.

Examples of the reinforcing wire 4 constituting the rigidity reinforcement ring 3 include organic fiber cords and steel cords. Examples of the organic fiber cord include a polyester fiber cord, a polyamide fiber cord, a rayon fiber cord, an aramid fiber cord, a polyethylene naphthalate fiber cord, a polyolefin ketone fiber cord, and an acrylic fiber cord. The twisted structure of these fiber cords may be determined as appropriate so as to achieve a predetermined tensile stress and compressive stress when formed into the rigidity reinforcement ring 3. Further, the reinforcing body is formed by winding the reinforcing wire 4 in a spiral-like manner in the tire circumferential direction while applying adequate tension to the reinforcing wire 4. The tensile stress in the circumferential direction of the rigidity reinforcement ring 3 can be regulated by the twisted structure of the reinforcing wire 4 and the tension during winding.

The rigidity reinforcement ring 3 is obtained by sandwiching and covering the reinforcing body formed by the reinforcing wire 4 described above between sheets of the unvulcanized rubber 5, and vulcanizing the covered reinforcing body. For the covering method of the unvulcanized rubber 5, the reinforcing wire 4 may be covered in advance with unvulcanized rubber, and the covered reinforcing wire 4 may be wound in a spiral-like manner in the tire circumferential direction.

Further, rubber components constituting the rigidity reinforcement ring 3 are not particularly limited, and may be rubber components that normally constitute a rubber composition for a vulcanization bladder or a rubber composition for a tire. Examples of the rubber components include butyl rubbers, silicon rubbers, fluororubbers, natural rubbers, isoprene rubbers, butadiene rubbers, and styrene butadiene rubbers.

A thickness of the rigidity reinforcement ring 3 is not particularly limited, but is preferably from 1 to 10 mm, and more preferably from 2 to 7 mm. When the thickness of the rigidity reinforcement ring 3 is less than 1 mm, the action of regulating the shape of the tire inner circumferential surface during vulcanization molding may not be adequately achieved. Further, when the thickness of the rigidity reinforcement ring 3 exceeds 10 mm, the action of reducing the circumferential length in the intermediate and subsequent stages of vulcanization molding may not be adequately achieved. Further, dependent on a shape, a size, and the like of the tire to be vulcanized, the optimum thickness of the rigidity reinforcement ring 3 is not uniform.

Here, the tire inner surface may need to be patterned into a desired shape. For example, ribs extending in the tire circumferential direction may need to be formed on the tire inner surface to increase straight ahead stability during running, or a platform may need to be formed on the tire inner surface to install an information device, a sensor device, or the like. While techniques for patterning the tire inner surface include forming recesses and protrusions on an outer surface of the bladder and transferring a shape of the recesses and protrusions to the tire inner surface, the bladder is a freely deflatable rubber bag, making it difficult to pattern the tire inner surface into a desired shape. Further, while it is possible to use a rigid inner ring as an inner mold, form recesses and protrusions on an outer surface of this rigid inner ring, and transfer the shape of the recesses and protrusions to the tire inner surface, a vulcanization device that includes the rigid inner ring has the disadvantages of lower versatility and increased equipment costs.

According to the present technology, as illustrated in FIG. 3, recesses 3A and protrusions 3B are disposed on an outer circumferential surface of the rigidity reinforcement ring 3, making it possible to pattern various shapes onto the tire inner surface. The recesses 3A and the protrusions 3B may be continuously or discontinuously disposed on the outer circumferential surface of the rigidity reinforcement ring 3. Preferably, the recesses 3A and the protrusions 3B continuously extend in the circumferential direction of the rigidity reinforcement ring 3.

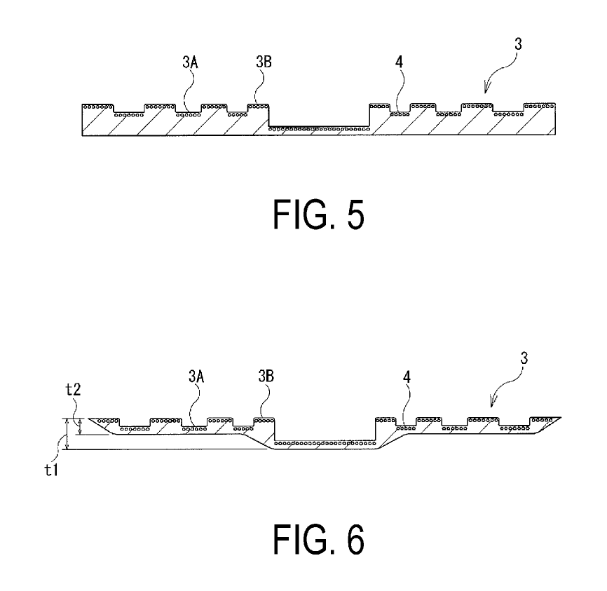

FIGS. 4 to 6 are cross-sectional views schematically illustrating examples of the recesses 3A and protrusions 3B of the rigidity reinforcement ring 3, each having a different cross-sectional shape. In the rigidity reinforcement ring 3 in FIG. 4, the recesses 3A and the protrusions 3B are alternately disposed with each having substantially the same width. In the rigidity reinforcement ring 3 in FIG. 5, the recesses 3A and the protrusions 3B are disposed with each of the recesses 3A having a different depth and width. Further, in the rigidity reinforcement ring 3 in FIG. 6, the outer circumferential surface includes substantially the same recesses 3A and protrusions 3B as those of the rigidity reinforcement ring 3 in FIG. 5 and a diameter of the inner circumferential surface is varied. As a result, a thickness t1 of a region of the rigidity reinforcement ring 3 at a center in a width direction differs from a thickness t2 of a region of the rigidity reinforcement ring 3 on an outer side in the width direction. In the rigidity reinforcement ring 3 in FIG. 6, the thickness from a bottom portion of the plurality of recesses 3A to the inner circumferential surface of the rigidity reinforcement ring 3 is substantially the same, allowing the pressure, when the bladder expands, to be substantially evenly transmitted to the green tire. Further, the rigidity reinforcement ring 3 is thinner overall, decreasing delays in thermal conductivity from the bladder to the green tire and making it possible to suppress an increase in vulcanization time.

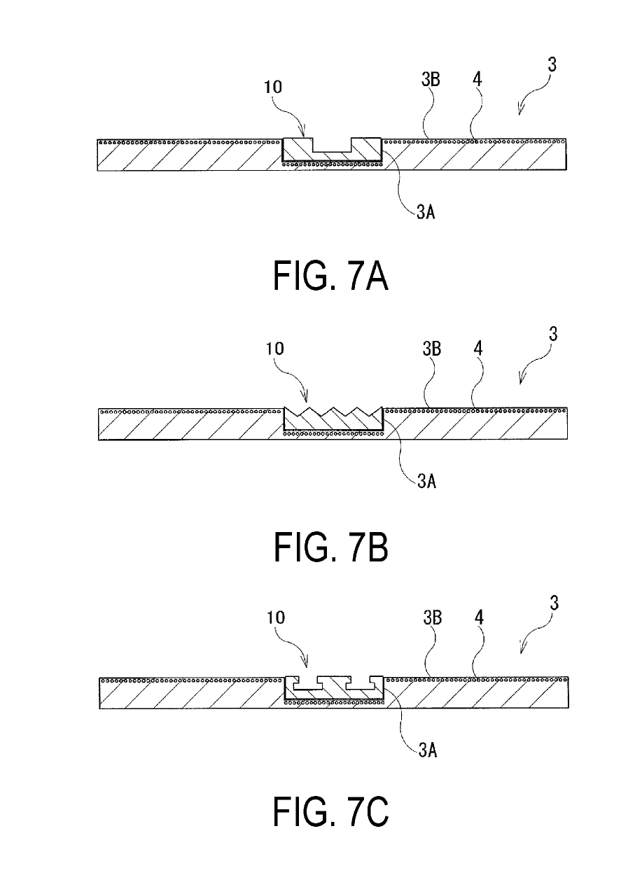

Further, as a method that supports variation of a various patterning, another auxiliary ring 10 may be fitted together with the recesses 3A of the rigidity reinforcement ring 3, as illustrated in FIGS. 7A to 7C. During vulcanization molding of the green tire T, the auxiliary ring 10, replaceable in accordance with various patterning shapes, is fitted together with the recesses 3A of the rigidity reinforcement ring 3 at the time of use, thereby making it possible to easily pattern various shapes onto the inner circumferential surface of the green tire. The auxiliary ring 10 illustrated in FIG. 7A includes a different recess. The auxiliary ring 10 illustrated in FIG. 7B includes an outer circumferential surface having a zig-zag shape. The auxiliary ring 10 illustrated in FIG. 7C includes recesses with a bottom portion having a wide width. Use of such an auxiliary ring 10 allows shape machining for attachment of a part, a sensor, or the like onto the tire inner surface to be performed during vulcanization.

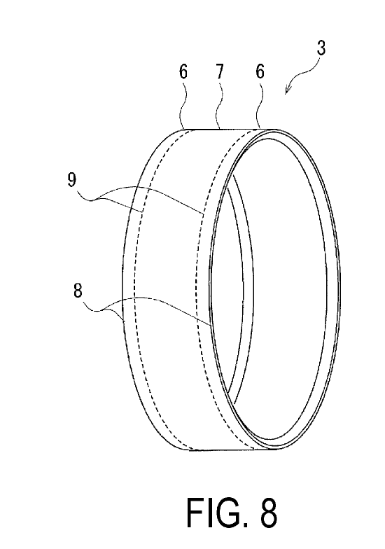

The rigidity reinforcement ring 3 according to the present technology allows a thickness of an end portion in the tire width direction to be less than a thickness of a center region, and a taper 6 is preferably provided from a predetermined position near the end portion in the width direction toward the end portion, gradually decreasing in thickness. That is, as illustrated in FIG. 8, the rigidity reinforcement ring 3 may include a main portion 7 and the tapered portion 6 disposed on both sides of the main portion 7. The main portion 7 has a substantially constant thickness t at the center of the rigidity reinforcement ring 3 in the width direction. The tapered portion 6 is disposed on both sides of the main portion 7, and is formed so that the thickness thereof gradually decreases from a thickness t of the main portion, from an inner end portion 9 that comes into contact with the main portion 7 toward an outer end portion 8 in the width direction of the rigidity reinforcement ring 3. Providing the tapered portions 6 to the rigidity reinforcement ring 3 makes it possible to subdue shape changes in the tire inner circumferential surface at boundary lines of the end portions of the rigidity reinforcement ring 3. That is, when the green tire T is vulcanized, the tapered portions 6 make it possible to decrease a size of a protrusion formed at a boundary between a region of the tire inner circumferential surface that comes into contact with the rigidity reinforcement ring 3 and a region of the tire inner circumferential surface that comes into contact with the bladder 2.

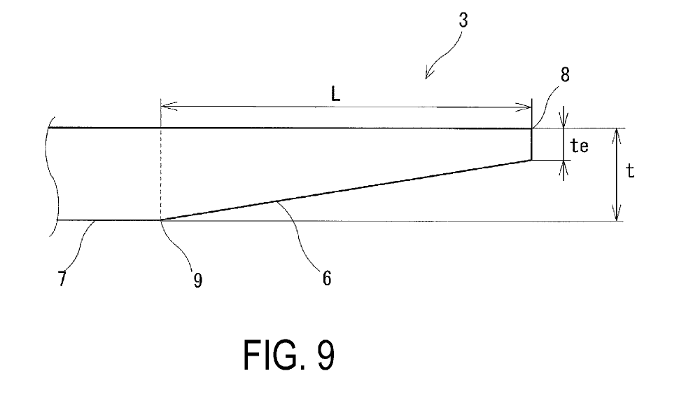

FIG. 9 is an enlarged cross-sectional view of the tapered portion 6 and a portion of the main portion 7 of the rigidity reinforcement ring 3. In FIG. 9, a thickness te of the outer end portion 8 of the tapered portion 6 is preferably not greater than one-half of the thickness t of the main portion 7 of the rigidity reinforcement ring 3. Making the thickness te of the outer end portion 8 of the tapered portion 6 not greater than one-half of the thickness t of the main portion 7 makes the appearance of the inner circumferential surface of the vulcanized tire excellent, suppresses failures such as dynamic fatigue during running, and makes it possible to ensure an adequate service life of the rigidity reinforcement ring 3 to be repeatedly used in vulcanization molding when repeatedly used in vulcanization molding. That is, failures such as dynamic fatigue during tire running are suppressed, making it possible to produce a higher quality tire. The thickness te of the outer end portion 8 of the tapered portion 6 is preferably from ⅙ to ½ and more preferably from ⅕ to ⅓ of the thickness t of the main portion 7.

Furthermore, in the present technology, a distance L from the outer end portion 8 to the inner end portion 9 of the tapered portion 6 preferably satisfies the relationship t≦L≦6t, and more preferably satisfies the relationship 2t≦L≦5t with respect to the thickness t of the main portion 7. Making the distance L greater than or equal to t allows a gradual incline and a reduced stepped state. Further, making the distance L less than or equal to 6t makes it possible to both improve a shape precision of the crown portion (tread portion) and promote pressure load and thermal transfer to the shoulder portion. Moreover, the outer end portion 8 of the tapered portion 6 serves as an outer end portion of the rigidity reinforcement ring 3 in the width direction, and the inner end portion 9 of the tapered portion 6 serves as a boundary with the main portion 7. The dimensions of the tapered portion 6 may be determined as appropriate according to tire type, shape, and the like.

The configuration of the rigidity reinforcement ring 3 is not particularly limited as long as the tensile stress in the circumferential direction is greater than the compressive stress. Examples of materials that constitute the rigidity reinforcement ring 3 include vulcanized rubbers, resins, and the like. The thickness t of the main portion 7 of the rigidity reinforcement ring 3 is not particularly limited, but is preferably from 1 to 10 mm, and more preferably from 2 to 7 mm. When the thickness of the main portion 7 of the rigidity reinforcement ring 3 is less than 1 mm, the action of regulating the shape of the tire inner circumferential surface during vulcanization molding may not be adequately achieved. Further, when the thickness of the main portion 7 of the rigidity reinforcement ring 3 exceeds 10 mm, the action of reducing the circumferential length in the intermediate and subsequent stages of vulcanization molding may not be adequately achieved. Further, dependent on the shape, size, and the like of the tire to be vulcanized, the optimum thickness of the main portion 7 is not uniform.

Further, in the rigidity reinforcement ring 3, preferably at least the tapered portion 6 is fiber reinforced. Fiber reinforcement of the tapered portion 6 makes it possible to increase a durability (number of times that the rigidity reinforcement ring 3 can be repeatedly used in vulcanization molding) of the rigidity reinforcement ring 3. In particular, when the tapered portion 6 is thin relative to the thickness tin a central portion and the rigidity reinforcement ring 3 is removed from the vulcanized tire after the green tire T is vulcanized, the tapered portion 6 may tear or become damaged, making the rigidity reinforcement ring 3 more susceptible to damage. Thus, fiber reinforcement of the tapered portion 6 is effective in increasing the durability of the rigidity reinforcement ring 3. Fiber reinforcement of the tapered portion 6 may be achieved by adhering fiber reinforcing material to the surface of the rigidity reinforcement ring 3 on the outer side or inner side in the radial direction, or by embedding the tapered portion 6 in the rubber that constitutes the rigidity reinforcement ring 3.

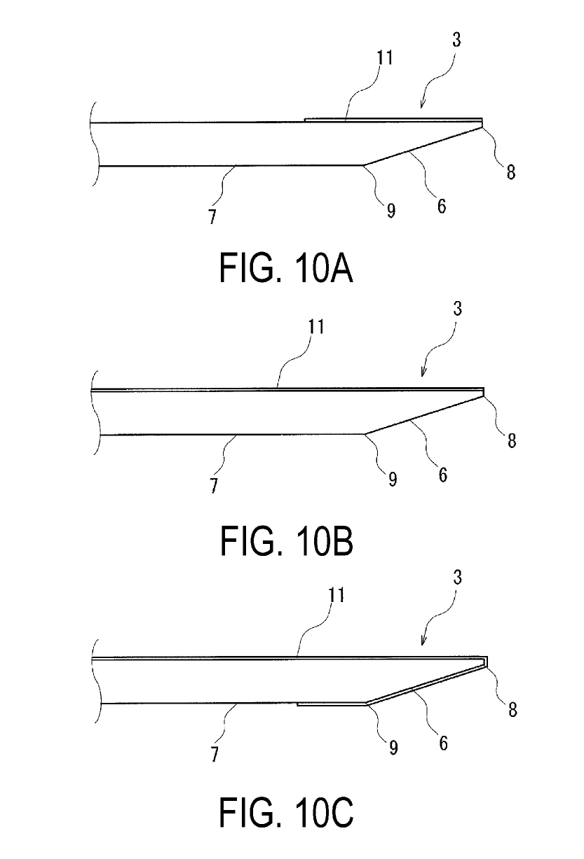

FIGS. 10A to 10C are cross-sectional views illustrating the tapered portion 6 partially enlarged. In FIGS. 10A to 10C, at least the tapered portion 6 is fiber reinforced. In the embodiment illustrated in FIG. 10A, the outer sides in the radial direction of the tapered portion 6 and a portion of the main portion 7 are fiber reinforced by a fiber reinforcing material 11. In the embodiment illustrated in FIG. 10B, an entire region in the width direction, that is, the outer side in the radial direction of the entire width of the tapered portion 6 and the main portion 7 is fiber reinforced by the fiber reinforcing material 11. In the embodiment illustrated in FIG. 10C, the inner sides in the radial direction of the tapered portion 6 and a portion of the main portion 7 are fiber reinforced by the fiber reinforcing material 11 in addition to that in the embodiment in FIG. 10B. Note that the range of fiber reinforcement is not particularly limited nor restricted to those in the examples described above as long as the range includes at least the tapered portion 6. Furthermore, the range may be both sides of the outer side and the inner side in the radial direction of the rigidity reinforcement ring 3, one side of the outer side in the radial direction, or one side of the inner side in the radial direction. With the type and the shape of the tire to be vulcanized resulting in differences in ease of removal after tire vulcanization, the state of the protruding sections transferred to the tire, and the like, the range of fiber reinforcement by the fiber reinforcing material 11 may be determined as appropriate.

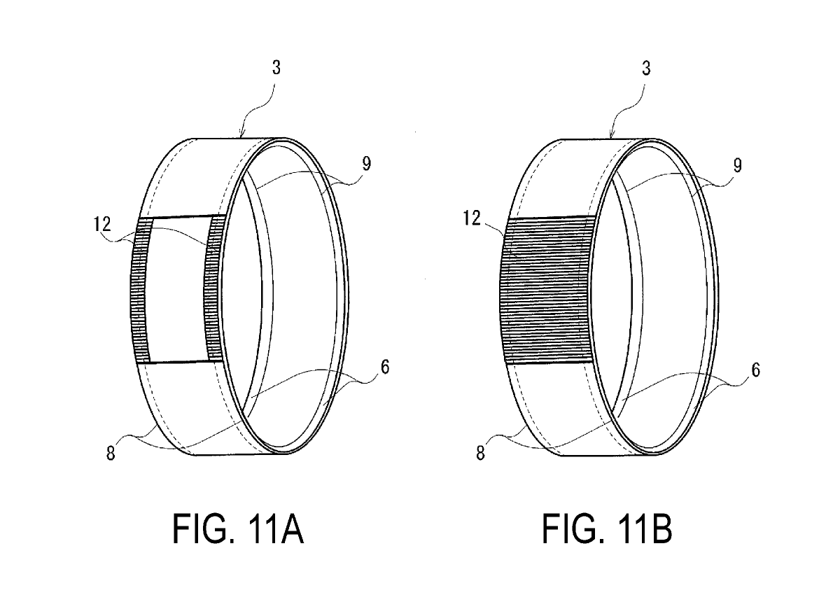

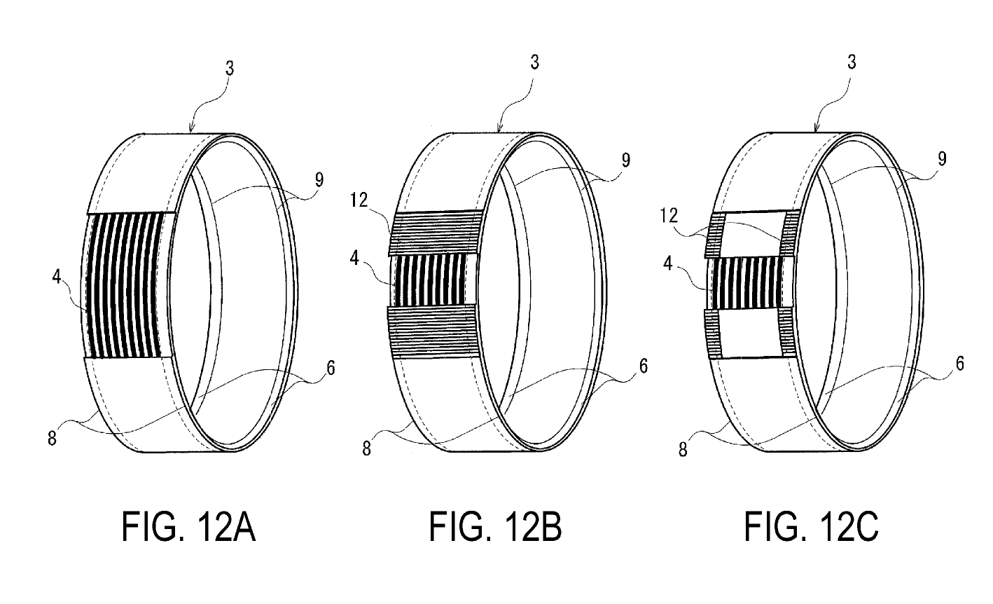

Further, FIGS. 11A and 11B are each a schematic perspective view illustrating, in its entirety, the rigidity reinforcement ring 3 with at least the tapered portion 6 fiber reinforced and a portion of an external surface removed. In the embodiment illustrated in FIG. 11A, the outer sides in the radial direction of the tapered portion 6 and a portion of the main portion 7 are fiber reinforced by a fiber reinforcing material 12. In the embodiment illustrated in FIG. 11B, an entire region in the width direction, that is, the outer side in the radial direction of the entire width of the tapered portion 6 and the main portion 7 is fiber reinforced by the fiber reinforcing material 12.

Examples of the fiber reinforcing materials 11, 12 used include a polyester fiber, a polyamide fiber, a rayon fiber, an aramid fiber, a polyethylene naphthalate fiber, a polyolefin ketone fiber, and an acrylic fiber. Note that the fiber reinforcing materials 11, 12 may be thread or cloth, and the fiber direction is not limited. Examples of the fiber reinforcement method include a method of layering a cloth impregnated with rubber on the rigidity reinforcement ring 3 and performing vulcanization. The fiber that constitutes the fiber reinforcing materials 11, 12 preferably forms an angle of 30° or greater, more preferably from 30° to 60°, with respect to the circumferential direction of the rigidity reinforcement ring. This makes it possible to efficiently strengthen a connection between the tapered portion 6 and the main portion 7.

In the present technology, the rigidity reinforcement ring 3 that includes the tapered portion 6 preferably further includes a reinforcing wire 4 that is wound in a tire circumferential direction, as illustrated in FIGS. 12A to 12C. FIGS. 12A to 12C are schematic perspective views illustrating embodiments of the rigidity reinforcement ring 3, each with a portion of the external surface and a portion of the layers on the inner side thereof removed. In the rigidity reinforcement ring 3 illustrated in FIG. 12A, the reinforcing body obtained by winding the reinforcing wire 4 having a twisted structure in the tire circumferential direction is embedded into the main portion 7. In the example in FIG. 12A, the inner end portion 9 of the tapered portion 6 is positioned on the outer side in the width direction of the reinforcing wire 4. However, the position of the inner end portion 9 is not limited to that in this example, and may be layered in the width direction with the reinforcing body formed by the reinforcing wire 4. FIG. 12B is a perspective view of the rigidity reinforcement ring 3 in an embodiment in which the outer sides in the radial direction of the main portion 7 and the tapered portions 6 in FIG. 12A are fiber reinforced by the fiber reinforcing material 12 oriented in the width direction of the ring. FIG. 12C is a perspective view of the rigidity reinforcement ring 3 in an embodiment in which the outer sides in the radial direction of the tapered portions 6 and a portion of the main portion 7 in FIG. 12A are fiber reinforced by the fiber reinforcing material 12 oriented in the width direction of the ring. The fiber reinforcing material 12 may also be combined with the reinforcing body that uses the reinforcing wire 4 as illustrated in FIGS. 12B and 12C. Combining the fiber reinforcing material 12 with the reinforcing body that uses the reinforcing wire 4 makes it possible to further improve the durability of the rigidity reinforcement ring 3. Note that the range of fiber reinforcement is not particularly limited.

The rigidity reinforcement ring according to the present technology may be configured as a rigidity reinforcement ring 13 that includes a side ring 14 on both sides in the width direction of the main portion 7 formed by a cylindrical ring. The side ring 14 may be a ring having a hollow truncated cone shape that is open on both sides. This side ring 14 preferably extends from a tread portion T1 of the green tire so as to come into contact with an entire inner side surface of a region corresponding to the bead portion T3. That is, the rigidity reinforcement ring 13 is a ring disposed so as to come into contact with the entire inner side surface of the region corresponding to that from the tread portion T1 to the bead portion T3 of the green tire T. In the tread portion T1 and the bead portion T3 of this ring, a stress required to cause a predetermined amount of tensile deformation in the circumferential direction is greater than a stress required to cause a predetermined amount of compressive deformation in the circumferential direction.

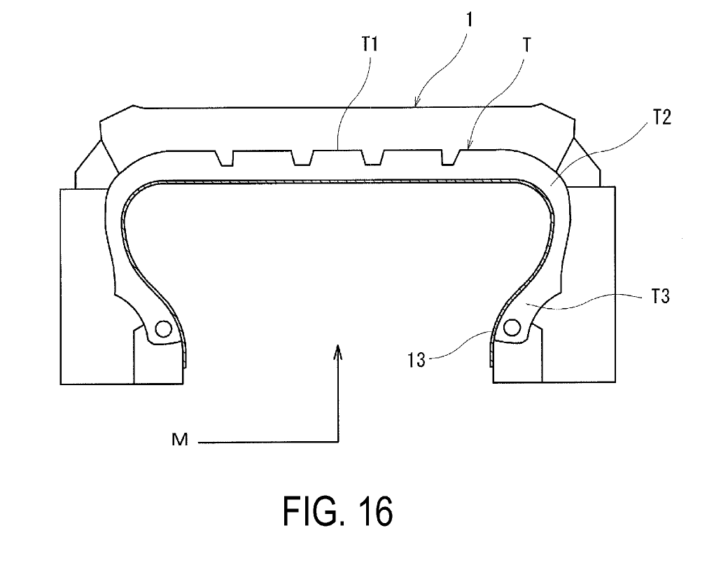

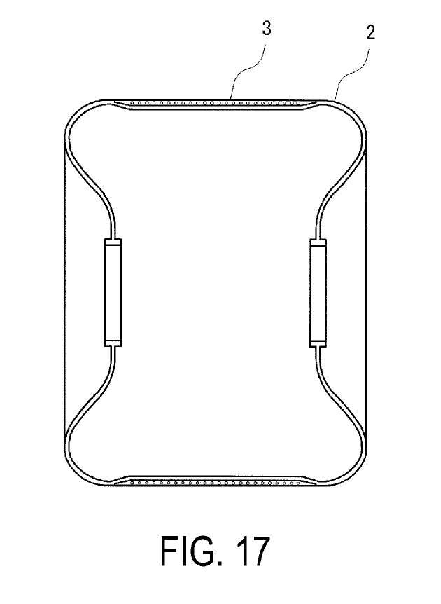

FIG. 16 is an explanatory view schematically illustrating the mold 1, the rigidity reinforcement ring 13, and the green tire T during bladder-less vulcanization. FIG. 16 illustrates a state in which the green tire T is pressed against an inner surface of the mold 1 by the injection of a heating medium M. Further, the green tire T is formed by the tread portion T1, the side portion T2, and the bead portion T3.

In this embodiment, the green tire T is formed into a shape close to the tire shape after vulcanization, and the rigidity reinforcement ring 13 is disposed so as to come into contact with the entire inner side surface of the region corresponding to that from the tread portion T1 to the bead portion T3 of the green tire T. In the rigidity reinforcement ring 13, a stress required to cause a predetermined amount of tensile deformation in the circumferential direction in the tread portion and the bead portion is greater than a stress required to cause a predetermined amount of compressive deformation in the circumferential direction. That is, the rigidity reinforcement ring 13 is susceptible to contracting and not susceptible to elongation in the tire circumferential direction. Further, the rigidity reinforcement ring 13 has airtight characteristics under high temperature and high pressure, and thus the green tire is pressed against the mold inner surface on the outer side in the tire radial direction by the heating medium injected during bladder-less vulcanization, and vulcanized.

With the rigidity reinforcement ring 13 disposed during bladder-less vulcanization, it is possible to achieve an excellent shape of the tire inner side. Further, the dimensional precision of the tire in the region corresponding to that from the tread portion to the bead portion can be enhanced.

In addition to a large tensile stress in the circumferential direction, the rigidity reinforcement ring 13 has a small compressive stress in the circumferential direction. During the initial stage of vulcanization molding of a tire, vulcanization of rubbers, such as a belt layer and a carcass near the tire inner surface, progresses. During the intermediate and subsequent stages, vulcanization of the entire tire cross section, including the tire interior, progresses. With the progression of vulcanization of unvulcanized rubber, the rubber increases in volume by thermal expansion. As a result, when vulcanization of the entire tire cross section progresses in the intermediate and subsequent stages, the vulcanized rubber near the tire inner surface, having started vulcanization in the initial stage by thermal expansion, deforms on the inner side in the radial direction in such a way that a circumferential length of the tire cavity contracts. Thus, the rigidity reinforcement ring 2 having a circumferential length that expanded during the initial stage of vulcanization molding needs to be reduced in circumferential length in the intermediate and subsequent stages. The rigidity reinforcement ring 13 according to the present technology has a small compressive stress in the circumferential direction, allowing the rigidity reinforcement ring 3 to follow a behavior of the vulcanized rubber in the intermediate and subsequent stages and prevent the occurrence of failures such as buckling.

The shape of the rigidity reinforcement ring 13 is not particularly limited as long as the shape is a ring that comes into contact with the entire inner side surface of the region corresponding to that from the tread portion to the bead portion of the green tire. Preferably, the shape is a cylindrical ring in the region that comes into contact with the inner side of the tread portion T1, and a ring having a hollow truncated cone shape that is open on both sides in the region that comes into contact with the inner side from the side portion T2 to the bead portion T3.

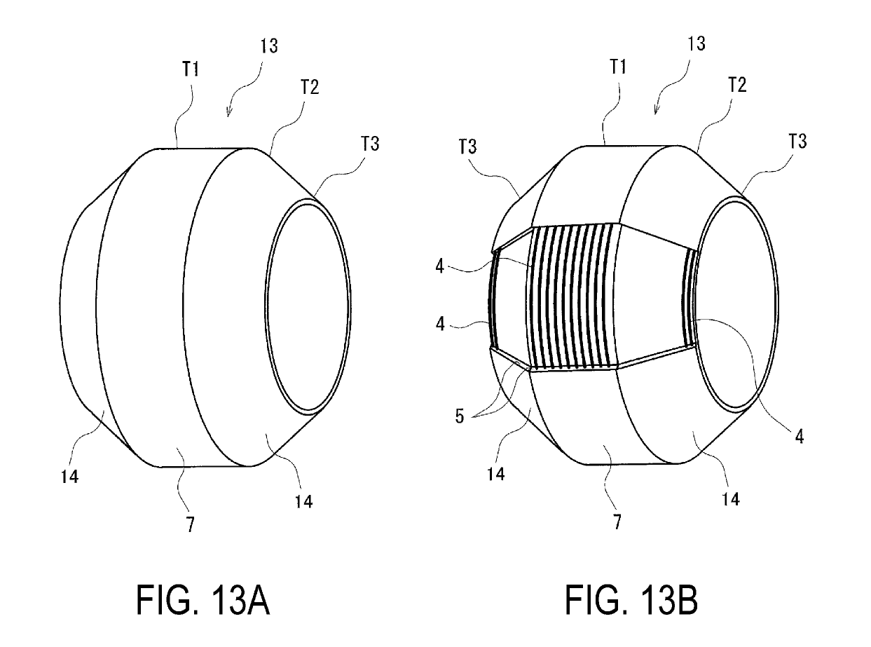

FIGS. 13A and 13B are explanatory views schematically illustrating an example of an embodiment of the rigidity reinforcement ring 13. As illustrated in FIGS. 13A and 13B, the rigidity reinforcement ring 13 is a cylindrical ring with both sides having a decreased diameter. That is, the rigidity reinforcement ring 13 has a combined shape of a cylindrical ring and a ring having a hollow truncated cone shape connected to both sides of the cylindrical ring. While the dimensions of the rigidity reinforcement ring 13 are not particularly limited, an outer diameter of the ring is preferably substantially equivalent to an inner diameter of the vulcanized tire. This makes it possible to adjust the shape of the inner side in the radial direction of the region corresponding to that from the tread portion to the bead portion of the tire.

While FIG. 13A illustrates the rigidity reinforcement ring 3 having a cylindrical shape with the outer diameter of the region corresponding to the tread portion uniform in the tire width direction, the outer diameter of the tread portion, that is, the main portion 7, of the rigidity reinforcement ring 13 is not limited to that in the illustrated example. For example, when a pneumatic tire designed with a tread portion having a linear inner circumferential edge is manufactured, the rigidity reinforcement ring 13 illustrated in FIG. 13A may be used as is. On the other hand, when a pneumatic tire designed with a tread portion having an arc-shaped inner circumferential edge is manufactured, the outer diameter of the rigidity reinforcement ring 13 may be changed in the tire width direction so as to follow the designed arc. The side ring 14 corresponding to the region from the side portion to the bead portion may also be similarly designed. That is, the shape of the rigidity reinforcement ring 13 formed by the main portion 7 and the side rings 14 may be determined in accordance with the cross-sectional shape of the designed tire. This makes it possible to further increase the degree of freedom in tire designing.

The configuration of the rigidity reinforcement ring 13 is not particularly limited as long as the tensile stress in the circumferential direction is greater than the compressive stress. For example, the rigidity reinforcement ring 13, as illustrated in FIG. 13B, is preferably a ring obtained by covering a reinforcing body with the unvulcanized rubber 5, and then vulcanizing the covered reinforcing body. In such a configuration, the reinforcing body is obtained by winding the reinforcing wire 4 having a twisted structure in at least the tire circumferential direction, in the tread portion T1 and the bead portion T3. With a configuration in which the rigidity reinforcement ring 3 is configured with the reinforcing wire 4 embedded in the tread portion T1 and the bead portion T3, it is possible to increase the tensile stress in the circumferential direction and decrease the compressive stress in the circumferential direction. Further, the rigidity reinforcement ring 13 is a ring made of a vulcanized rubber and can be easily separated and removed from the inner side of the vulcanized tire removed from the mold 1 due to non-adherence to the unvulcanized or vulcanized rubber.

Further, the reinforcing body is formed by winding the reinforcing wire 4 in a spiral-like manner in the tire circumferential direction while applying adequate tension to the reinforcing wire 4, in the regions corresponding to the tread portion T1 and the bead portion T3. A wire density of the reinforcing wire 4 may be determined in accordance with the tensile stress in the circumferential direction, and the wire densities in the tread portion T1 and the bead portion T3 may be the same or different.

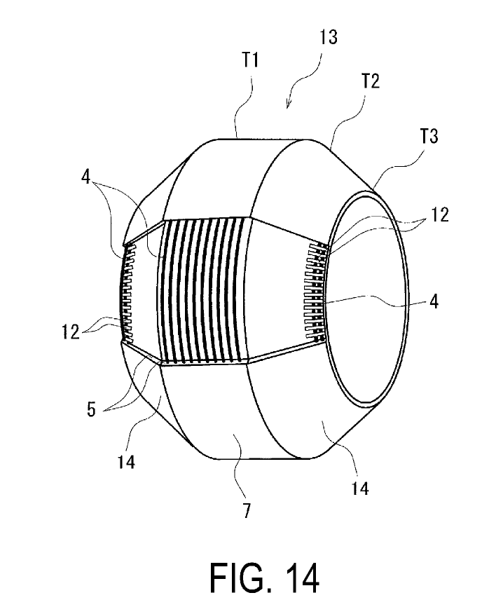

The rigidity reinforcement ring 13, as illustrated in FIG. 14, is preferably disposed in the region corresponding to the bead portion T3 with a plurality of the fiber reinforcing materials 12 extending in the tire radial direction spaced apart in the tire circumferential direction. That is, an unvulcanized rubber sheet obtained by aligning and rubber coating the fiber reinforcing material 12 may be layered so that the fiber reinforcing material 12 extends in the tire radial direction, or the fiber reinforcing material 12 having a cord fabric structure may be embedded in the bead portion T3. With the fiber reinforcing material 12 extending in the radial direction along with the reinforcing wire 4 wound in the circumferential direction disposed in this way, a rigidity of the bead portion T3 of the rigidity reinforcement ring 3 increases, making it possible to more effectively press the bead portion of the green tire when performing bladder-less vulcanization and thus increase the durability of the rigidity reinforcement ring 13 that is required. The cord density of the fiber reinforcing material 12 may be determined as appropriate in accordance with the durability required by the bead portion. Note that the types and structures of the reinforcing wire 4 wound in the circumferential direction and the fiber reinforcing material 12 extending in the radial direction may be the same or different.

Examples of the reinforcing wire 4 and the fiber reinforcing material 12 constituting the rigidity reinforcement ring 13 include organic fiber cords and steel cords. Examples of the organic fiber cord include a polyester fiber cord, a polyamide fiber cord, a rayon fiber cord, an aramid fiber cord, a polyethylene naphthalate fiber cord, a polyolefin ketone fiber cord, and an acrylic fiber cord. The twisted structure of these fiber cords may be determined as appropriate so as to achieve a predetermined tensile stress and compressive stress or a predetermined durability when formed into the rigidity reinforcement ring 13. The tensile stress in the circumferential direction of the rigidity reinforcement ring 13 can be regulated by the twisted structure of the reinforcing wire 4 and the tension when winding the reinforcing wire 4 in a spiral-like manner in the circumferential direction.

The rigidity reinforcement ring 13 is obtained by sandwiching and covering the reinforcing body formed by the reinforcing wire 4 and fiber reinforcing material 12 described above between sheets of the unvulcanized rubber 5, and vulcanizing the covered reinforcing body. For the covering method of the unvulcanized rubber 5, a rubber strap obtained by covering the reinforcing wire 4 with unvulcanized rubber may be prepared in advance and wound in a spiral-like manner in the tire circumferential direction.

Further, the rubber components constituting the rigidity reinforcement ring 13 are not particularly limited, and may be rubber components that normally constitute a rubber composition for a tire. Examples of the rubber components include natural rubbers, isoprene rubbers, butadiene rubbers, and styrene butadiene rubbers.

A thickness of the rigidity reinforcement ring 13 is not particularly limited, but is preferably from 1 to 10 mm, and more preferably from 2 to 5 mm. When the thickness of the rigidity reinforcement ring 13 is less than 1 mm, the effect of regulating the shape of the tire inner circumferential surface during vulcanization molding may not be adequately achieved. Further, when the thickness of the rigidity reinforcement ring 13 exceeds 10 mm, the effect of reducing the circumferential length in the intermediate and subsequent stages of vulcanization molding may not be adequately achieved.

In the following, a vulcanizing method for pneumatic tires that use the rigidity reinforcement rings 3, 13 will be described. The rigidity reinforcement rings 3, 13 may be simply used along with the existing bladder 2 and vulcanization molded, thereby maintaining the productivity to date and not causing increases in manufacturing costs. Further, the rigidity reinforcement ring 13 can be used in bladder-less vulcanization, making it possible to achieve an excellent inner surface shape of the tire and increase dimensional precision while maintaining favorable productivity by simply disposing the rigidity reinforcement ring 13 in the inner circumferential surface of the green tire.

In the tire vulcanizing method according to the present technology, as illustrated in FIG. 1, vulcanization molding is performed by setting the green tire T, with the rigidity reinforcement ring 3 described above interposed between the inner circumferential surface of the region of the green tire T corresponding to the tread portion T1 and the outer circumferential surface of the bladder 2, in the mold 1, and expanding the bladder 2. With the rigidity reinforcement ring 3 externally fitted around the outer periphery of the bladder 2 as previously described, the shape of the tire inner circumferential side is regulated by the peripheral shape of the rigidity reinforcement ring 3, and the pressure of the green tire in the shoulder portion can be effectively applied.

In the vulcanizing method according to the present technology, a green tire assembly obtained by integrally assembling the constituent members of the green tire T to the outer periphery of the rigidity reinforcement ring 3 may be manufactured, and then set in the mold 1. This makes it possible to reliably dispose the rigidity reinforcement ring 3 on the inner circumferential surface of the region of the green tire T corresponding to the tread portion T1, and further increase the dimensional precision of the tire.

Further, as another embodiment, the green tire assembly may be manufactured by forming the green tire T in advance using a normal method and inserting the rigidity reinforcement ring 3 into the cavity of the obtained green tire T, and the green tire assembly may then be set in the mold 1. This makes it possible to easily manufacture the green tire assembly.

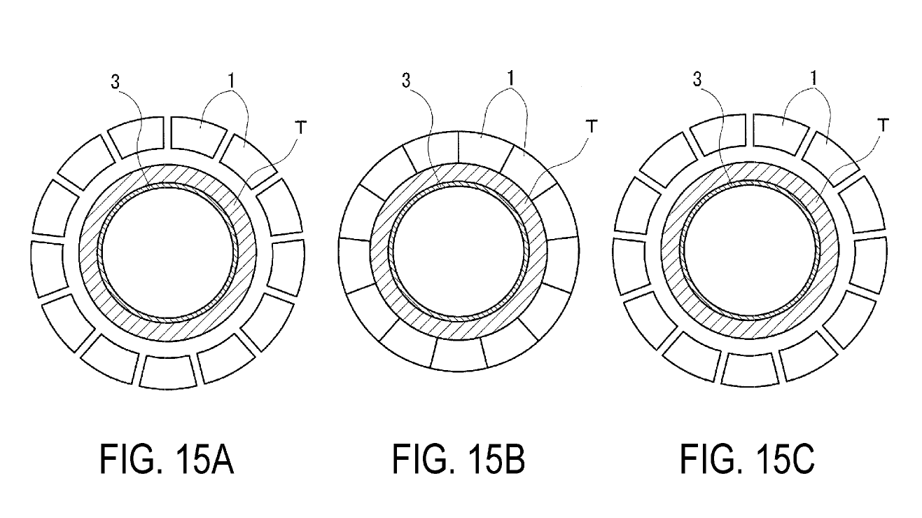

For the mold in which the obtained green tire assembly is set, a mold divisible into a plurality of sections may be preferably used, as illustrated in FIGS. 15A to 15C. FIGS. 15A to 15C are explanatory views schematically illustrating the closing and opening of the mold during vulcanization molding, in cross-sectional views in a tire equator direction. FIG. 15A is a cross-sectional view of the mold 1, the green tire T, and the rigidity reinforcement ring 3 in the tire equator direction when the green tire is set in the mold, FIG. 15B is a cross-sectional view of the same during vulcanization, and FIG. 15C is a cross-sectional view of the same when the vulcanized tire is removed. Note that, in FIGS. 15A to 15C, the bladder is omitted.

As illustrated in FIG. 15A, use of the sectional mold 1 divisible into a plurality of sections makes it easier to set the green tire assembly having substantially the same diameter as the diameter of the vulcanization molded tire in the mold 1. The number of divides of such a sectional mold may be determined in accordance with tire shape and tire size.

The pneumatic tire obtained by the tire vulcanizing method according to the present technology has dimensional precision close to the designed value, making it possible to more reliably achieve the intended tire performance. For example, the pneumatic tire formed by vulcanization molding using the rigidity reinforcement ring having a cylindrical shape illustrated in FIG. 2A makes it possible to flatten the tread portion, prevent the thickness of a central region of the tread portion from decreasing, and make the thickness of the tread portion substantially uniform. This makes it possible to further reduce a rolling resistance of the pneumatic tire.

Further, in the tire vulcanizing method according to the present technology, as illustrated in FIG. 16, bladder-less vulcanization is performed by injecting the heating medium M with the rigidity reinforcement ring 13 described above disposed across the entire inner side surface of the region corresponding to that from the tread portion T1 to the beam portion T3 of the green tire T set in the mold 1. Bladder-less vulcanization using the rigidity reinforcement ring 13 makes it possible to achieve an excellent inner surface shape of the vulcanized tire and increase dimensional precision. Further, the rigidity reinforcement ring 13 may be simply disposed on the inner circumferential surface of the green tire, making it possible to maintain favorable bladder-less vulcanization productivity.

In the vulcanizing method according to the present technology, preferably a green tire assembly obtained by integrally assembling the constituent members of the green tire T to the outer periphery of the rigidity reinforcement ring 13 is manufactured and set in the mold 1, and bladder-less vulcanization is performed. This makes it possible to reliably dispose the rigidity reinforcement ring 13 on the inner circumferential surface of the region corresponding to that from the tread portion T1 to the bead portion T3 of the green tire T.

For the mold in which the obtained green tire assembly is set, a sectional mold divisible into a plurality of sections may be preferably used. Use of the mold 1 divisible into a plurality of sections makes it easier to set the green tire assembly having substantially the same diameter as the diameter of the vulcanization molded tire in the mold 1. The number of divides of such a sectional mold may be determined in accordance with tire shape and tire size.

In the present technology, the pneumatic tire obtained by the bladder-less tire vulcanizing method has a tire shape and dimensional precision close to the designed values, making it possible to more reliably achieve the intended tire performance. For example, the pneumatic tire formed by bladder-less vulcanization using the rigidity reinforcement ring illustrated in FIG. 13A makes it possible to flatten the tread portion, make the thickness substantially uniform, and achieve an excellent inner surface shape. This makes it possible to further reduce the rolling resistance of the pneumatic tire.

The present technology is further described below using Working Examples. However, the scope of the present technology is not limited to these Working Examples.

### Examples

### Working Examples 1 to 4

Green tires (tire size 205/55R16) having identical specifications were manufactured. Each of the green tires was formed by performing vulcanization molding with a rigidity reinforcement ring in Working Examples 1 to 4, and without a rigidity reinforcement ring in Comparative Example 1. Note that the rigidity reinforcement ring used was a cylindrical ring (diameter: 570 mm, thickness t: 2.3 mm) obtained by winding a polyester fiber cord (a cord having a total linear density of 2200 dtex and a twisted structure of 46×46 (two-cord twist)) in a spiral-like manner in the tire circumferential direction using an end count of 50 per 50 mm, covering the wound body with a butyl rubber, and performing vulcanization. Further, a rigidity reinforcement ring without a tapered portion was used in Working Example 1, and a rigidity reinforcement ring with tapered portions having the dimensions shown in Table 1 was used in each of the Working Examples 2 to 4. The rigidity reinforcement rings used in Working Examples 2 to 4 were each given a different distance L from the outer end portion to the inner end portion of the tapered portion, and a different thickness to of the outer end portion, as shown in Table 1. Further, the rigidity reinforcement ring used in Working Example 4 was obtained by adhering together plain woven fabric (polyester fiber, 200 dtex, cord density of 10 cords per 12.7 mm width for warp and woof) impregnated with rubber across an entire width of an outer side in the radial direction before vulcanization so that the cords were arranged at an angle of ±45° with respect to the circumferential direction, and using the adhered plain woven fabric to form a vulcanized rigidity reinforcement ring with a fiber-reinforced tapered portion.

TABLE 1

| | | Working | Working | Working | Working | Comparative |
|---|---|---|---|---|---|---|
| | | Example 1 | Example 2 | Example 3 | Example 4 | Example 1 |
| Vulcanizing method | | Rigidity | Rigidity | Rigidity | Rigidity | Rigidity |
| | | reinforcement | reinforcement | reinforcement | reinforcement | reinforcement |
| | | ring used | ring used | ring used | ring used | ring not used |
| Thickness t [mm] of ring | | 2.3 | 2.3 | 2.3 | 2.3 | — |
| (main portion) | | | | | | |
| Presence/absence of | — | Absent | Present | Present | Present | — |
| tapered portion | | | | | | |
| Ratio of distance L to | L/t [—] | L = 0 | 4 | 4 | 4 | — |
| thickness t | | | | | | |
| Ratio of thickness te to | te/t [—] | 1 | 1/2 | 1/3 | 1/3 | — |
| thickness t | | | | | | |
| Presence/absence of | — | Absent | Absent | Absent | Present | — |
| fiber reinforcement | | | | | | |
| Appearance of tire | — | Protrusions | Protrusions | Protrusions | Protrusions | Good |
| inner circumferential | | with an | with an | with an | with an | |
| surface | | approximate | approximate | approximate | approximate | |
| | | 2 mm height | 1 mm height | 0.7 mm height | 0.7 mm height | |
| | | present | present | present | present | |
| State of inner | — | Cracks | Good | Good | Good | Good |
| circumferential surface | | | | | | |
| after durability test | | | | | | |
| Service life of ring and | [times] | 420 | 400 | 350 | 500 | — |
| the like during | | | | | | |
| vulcanization molding | | | | | | |
| Rolling resistance | Index | 90 | 90 | 90 | 90 | 100 |
| | value | | | | | |

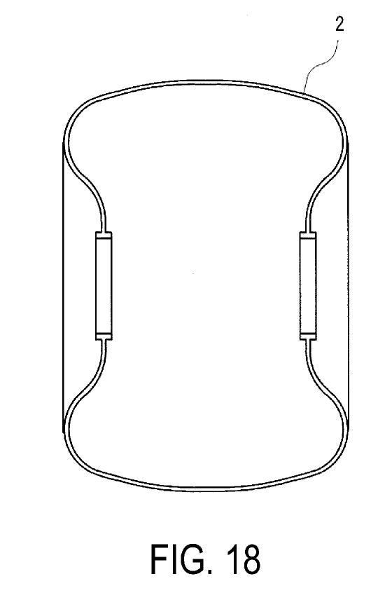

FIG. 17 and FIG. 18 illustrate the simulation results of a cross sectional embodiment of a bladder expanded during vulcanization molding in Working Example 1 and Comparative Example 1, respectively. In the cross-sectional embodiment in which the bladder was expanded in Working Example 1 illustrated in FIG. 17, the region corresponding to the tread portion is flat, making it possible to vulcanize the pneumatic tire having a flattened tread portion with a substantially uniform thickness. Furthermore, the bladder is expected to expand to the shoulder portion of the tire as well and adequately press the shoulder portion.

On the other hand, in the cross-sectional embodiment of the expanded bladder of Comparative Example 1 illustrated in FIG. 18, the bladder balloons to the outer side in the radial direction in the region corresponding to the tread portion. As a result, when an attempt is made to perform vulcanization molding on the pneumatic tire with the flattened tread portion, the thickness in the central region of the tread portion may decrease. Further, the expansion of the bladder to the shoulder portion of the tire is found to be minimal compared to that of Working Example 1.

Upon observation of the inner circumferential surfaces of the tires obtained by Working Examples 1 to 4 and Comparative Example 1, the inner circumferential surfaces of the tires of Working Examples 1 to 4 were each found to have a flat cross-sectional shape in the region corresponding to the tread portion. In comparison, the inner circumferential surface of the tire of Comparative Example 1 was found to have a curved receding cross-sectional shape in the region corresponding to the tread portion and a non-uniform rubber thickness in the tread portion. Further, on each of the inner circumferential surfaces of the tires of Working Example 2 to 4, protrusions having a thickness less than the thickness to were formed at the ends of the contact area with the rigidity reinforcement ring. In Working Example 1, protrusions having a thickness less than the thickness t were formed at the ends of the contact area with the rigidity reinforcement ring.

Each tire obtained in Working Examples 1 to 4 and Comparative Example 1 was mounted on a rim (16×6.5J) and filled to an air pressure prescribed by JATMA (Japan Automobile Tyre Manufacturers Association, Inc.). The tire was placed on an indoor drum tester (drum diameter: 1707 mm) prescribed by JIS (Japanese Industrial Standard) D4230, and the resistance was measured at a test load of 2.94 kN and a speed of 50 km/hr and used as the rolling resistance. The results were entered in the “Rolling resistance” row of Table 1 as index values with the resistance value of the tire of Comparative Example 1 being defined as 100. Smaller index values indicate a lower and superior rolling resistance. As understood from Table 1, the resistance of each of the tires in Working Examples 1 to 4 was 90. As a result, the pneumatic tires of Working Examples 1 to 4 formed by vulcanization molding using the method according to the present technology were each found to have a more flatly formed tread portion shape and a significantly reduced rolling resistance.

Next, the rigidity reinforcement rings of Working Examples 1 to 4 were used to repeatedly perform vulcanization molding, and the vulcanization counts until the rigidity reinforcement ring malfunctioned (number of usable times; service life of the rigidity reinforcement ring and the like; replacement time) were compared. The vulcanization counts were 420 for the cylindrical ring of Working Example 1, 400 for the rigidity reinforcement ring of Working Example 2, 350 for the rigidity reinforcement ring of Working Example 3, and 500 for the rigidity reinforcement ring of Working Example 4. According to the results of the rigidity reinforcement ring of Working Example 4, a service life equivalent to that of a cylindrical ring was maintained due to the fiber reinforcement of the tapered portion.

Each pneumatic tire obtained in Working Examples 1 to 4 and Comparative Example 1 was mounted on a rim (16×6.5J) and filled to an air pressure prescribed by JATMA. The tire was placed on an indoor drum tester (drum diameter: 1707 mm) prescribed by JIS D4230, and a tire durability test was conducted at a test load of 4.4 kN under variable speed conditions according to running time. As a result, the pneumatic tires of Working Examples 2 to 4 exhibited no problems in the state of the tire inner surface after the durability test. On the other hand, the pneumatic tire of Working Example 1 was found to have cracks in projecting sections. Thus, each of the pneumatic tires of Working Examples 2 to 4 were confirmed as having an excellent appearance of the tire inner circumferential surface and an improved tire durability due to a decreased protrusion size on the tire inner surface.

### Working Examples 5 and 6

Pneumatic tires (tire size 205/55R16) having identical specifications were manufactured. The pneumatic tires of Working Examples 5 and 6 and Comparative Examples 2 and 3 were manufactured by performing vulcanization molding by bladder surface processing or by using a rigid inner ring in Comparative Examples 2 and 3, and by performing vulcanization molding using a rigidity reinforcement ring in Working Examples 5 and 6.

Note that, in the rigidity reinforcement ring of Working Example 5, an inclined surface was not provided to either end portion of the rigidity reinforcement ring, as illustrated in FIG. 5. In the rigidity reinforcement ring of Working Example 6, an inclined surface was provided to each surface that comes into contact with the vulcanization bladder at a stepped portion formed by thick portions and thin portions having varied thicknesses in accordance with the depths of the recesses of the rigidity reinforcement ring, as illustrated in FIG. 6. Further, an inclined surface was provided to each surface that comes into contact with the vulcanization bladder on both end portions so that both end portions of the rigidity reinforcement ring gradually decreased in thickness toward the outer side in the width direction, as illustrated in FIG. 6.

These test tires were then evaluated in terms of patterning precision, manufacturing cost, versatility of vulcanizing method, and heat conduction efficiency. The results are shown in Table 2.

Patterning precision, versatility of vulcanizing method, and heat conduction efficiency:

For each of the items above, “Excellent” indicates an excellent value, “Good” indicates a good value, and “Poor” indicates a poor value.

Manufacturing Cost:

For manufacturing cost, “Excellent” indicates a significantly low manufacturing cost, “Good” indicates a low manufacturing cost, and “Poor” indicates a high manufacturing cost.

TABLE 2

| | Comparative | Comparative | Working Example | Working Example |
|---|---|---|---|---|
| | Example 2 | Example 3 | 5 | 6 |
| Patterning | Bladder | Rigid inner | Rigidity | Rigidity |
| method | surface groove | ring | reinforcement ring | reinforcement ring |
| | processing | | (stepped) | (inclined surface) |
| Patterning | Poor | Excellent | Excellent | Excellent |
| precision | | | | |
| Manufacturing | Excellent | Poor | Excellent | Excellent |
| cost | | | | |
| Versatility of | Excellent | Poor | Excellent | Excellent |
| vulcanizing | | | | |
| method | | | | |
| Efficiency of | Excellent | Excellent | Good | Excellent |
| heat conduction | | | | |

As understood from Table 2, the tires of Working Examples 5 and 6, manufactured using the rigidity reinforcement ring according to the present technology, exhibited high-precision patterning on the tire inner surface and low cost manufacturability. Further, the manufacturing method of such pneumatic tires is highly versatile.

### Working Example 7

Green tires (tire size 205/55R16) having identical specifications were manufactured. Bladder-less vulcanization was performed using the rigidity reinforcement ring illustrated in FIG. 13 in Working Example 7, and without a rigidity reinforcement ring in Comparative Example 4. Note that the rigidity reinforcement ring used was a ring designed to come into contact with the entire inner side surface of the region corresponding to that from the tread portion to the bead portion. Further, the ring used was a cylindrical ring (diameter: 570 mm, thickness t: 2.3 mm) obtained by winding a polyester fiber cord (a cord having a total linear density of 2200 dtex and a twisted structure of 46×46 (two-cord twist)) in a spiral-like manner in the tire circumferential direction using an end count of 50 per 50 mm, covering the wound body with a natural rubber, and performing vulcanization.

The inner surface shapes of the pneumatic tires obtained by bladder-less vulcanization in Working Example 7 and Comparative Example 4 were then visually observed. The pneumatic tire obtained in Working Example 7 exhibited an excellent tire inner surface shape as well as an excellent tread portion groove and sipe form. On the other hand, the pneumatic tire obtained in Comparative Example 4 exhibited an uneven tire inner surface shape without a favorable mold-pressed appearance. Further, flaws were observed in the tread portion groove and sipe form, and the bead portion shape was uneven with recesses and protrusions.

1. A rigidity reinforcement ring serving as a cylindrical ring that, when a green tire is set in a mold and a bladder is pressed from an inner side of the green tire to an outer side in a tire radial direction to perform vulcanization molding, is interposed between an inner circumferential surface of a region of the green tire corresponding to a tread portion and an outer circumferential surface of a region of a bladder corresponding to the tread portion; a stress required to cause a predetermined amount of tensile deformation in a circumferential direction of the ring being greater than a stress required to cause a predetermined amount of compressive deformation in the circumferential direction.

2. The rigidity reinforcement ring according to claim 1, wherein an outer diameter of the ring is substantially equivalent to an inner diameter of a vulcanized tire, a width of the ring is substantially equivalent to a width of the tread portion of the vulcanized tire, and the vulcanized tire and the bladder are separatable.

3. The rigidity reinforcement ring according to claim 1, wherein the ring is obtained by covering a reinforcing body with an unvulcanized rubber and vulcanizing the covered reinforcing body, the reinforcing body being obtained by winding a reinforcing wire having a twisted structure in at least a tire circumferential direction.

4. The rigidity reinforcement ring according to claim 1, wherein a tensile rigidity of the ring in the tire circumferential direction is greater than a tensile rigidity of the bladder in the tire circumferential direction.

5. The rigidity reinforcement ring according to claim 1, wherein the ring comprises recesses and protrusions on an outer circumferential surface thereof.

6. The rigidity reinforcement ring according to claim 5, wherein the recesses and protrusions of the ring continuously extend in the circumferential direction.

7. The rigidity reinforcement ring according to claim 1, wherein the ring is formed by a main portion having a thickness t and a tapered portion disposed on both sides of the main portion, and a thickness of the tapered portion gradually decreases from the thickness t toward an outer end portion in the width direction of the ring.

8. The rigidity reinforcement ring according to claim 7, wherein a thickness of the outer end portion of the tapered portion is not greater than one-half of the thickness t.

9. The rigidity reinforcement ring according to claim 7, wherein a distance L from the outer end portion to an inner end portion of the tapered portion has a relationship with the thickness t such that t≦L≦6t.

10. The rigidity reinforcement ring according to claim 7, wherein at least the tapered portion is fiber reinforced.

11. The rigidity reinforcement ring according to claim 10, wherein the outer side and/or inner side in the radial direction of the tapered portion is fiber reinforced.

12. The rigidity reinforcement ring according to claim 1, wherein the ring comprises a side ring on both sides in the width direction of the ring, and extends so that the side rings each come into contact with an entire inner side surface of a region corresponding to that from the tread portion to a bead portion of the green tire.

13. The rigidity reinforcement ring according to claim 12, wherein a plurality of the reinforcing wires having the twisted structure and identical or differing reinforcing wires are disposed so as to extend in the tire radial direction and be spaced apart in the tire circumferential direction, in the bead portion of each of the side rings.

14. A tire vulcanizing method comprising the steps of setting a green tire in a mold, inserting a bladder inside the green tire, expanding the bladder to press the bladder to an outer side in a tire radial direction, and performing vulcanization molding; the bladder being expanded with the rigidity reinforcement ring described in claim 1 interposed between an inner circumferential surface of a region of the green tire corresponding to a tread portion and an outer circumferential surface of a region of the bladder corresponding to the tread portion.

15. The tire vulcanizing method according to claim 14, further comprising the steps of manufacturing a green tire assembly obtained by integrally assembling constituent members of the green tire to an outer periphery of the rigidity reinforcement ring described in claim 1, and setting the green tire assembly in the mold.

16. The tire vulcanizing method according to claim 14, further comprising the steps of manufacturing a green tire assembly by inserting the rigidity reinforcement ring described in claim 1 into a cavity of a green tire formed in advance, and inserting the bladder inside the green tire assembly.

17. The tire vulcanizing method according to claim 15, further comprising the step of setting the green tire assembly in a mold divisible into a plurality of sections.

18. A rigidity reinforcement ring serving as a ring that, when a green tire is set in a mold and a heating medium is injected inside the green tire and then pressed to an outer side in the tire radial direction to perform bladder-less vulcanization, is disposed so as to come into contact with an entire inner side surface of a region corresponding to that from a tread portion to a bead portion of the green tire; a stress required to cause a predetermined amount of tensile deformation in the tread portion and the bead portion of the ring being greater than a stress required to cause a predetermined amount of compressive deformation in the circumferential direction.

19. The rigidity reinforcement ring according to claim 18, wherein the ring is obtained by covering a reinforcing body with an unvulcanized rubber and vulcanizing the covered reinforcing body, the reinforcing body being obtained by winding a reinforcing wire having a twisted structure in at least a tire circumferential direction, in the tread portion and the bead portion of the ring.

20. The rigidity reinforcement ring according to claim 19, wherein a plurality of the reinforcing wires having the twisted structure and identical or differing reinforcing wires are disposed so as to extend in the tire radial direction and be spaced apart in the tire circumferential direction, in the bead portion of the ring.

21. A tire vulcanizing method serving as a bladder-less vulcanizing method comprising the steps of setting a green tire in a mold, injecting a heating medium inside the green tire, and pressing the heating medium to an outer side in a tire radial direction; the heating medium being injected in a state with the rigidity reinforcement ring described in claim 18 disposed across an entire inner side surface of a region corresponding to that from a tread portion to a bead portion of the green tire.

22. The tire vulcanizing method according to claim 21, further comprising the steps of manufacturing a green tire assembly obtained by integrally assembling constituent members of the green tire to an outer periphery of the rigidity reinforcement ring described in claim 18, and setting the green tire assembly in the mold.

23. The tire vulcanizing method according to claim 22, further comprising the step of setting the green tire assembly in a mold divisible into a plurality of sections.
